(19) United States
(12) Patent Application Publication
(10) Pub. No.: US 2015/0089413 A1
(43) Pub. Date: Mar. 26, 2015

(54) INFORMATION DISPLAY CONTROL DEVICE, INFORMATION DISPLAY CONTROL METHOD, AND STORAGE MEDIUM CONTAINING PROGRAM STORED THEREON

(71) Applicant: CASIO COMPUTER CO., LTD., Tokyo (JP)

(72) Inventors: Yoshinori ASAYAMA, Tokyo (JP); Takashi KOJO, Tokyo (JP)

(73) Assignee: CASIO COMPUTER CO., LTD., Tokyo (JP)

(21) Appl. No.: 14/490,532

(22) Filed: Sep. 18, 2014

(30) Foreign Application Priority Data
Sep. 20, 2013 (JP) 2013-195314

(51) Int. Cl. G06F 3/0481; G06F 3/0484

(52) U.S. Cl. CPC G06F 3/04817; G06F 3/0484
USPC 715/765

(57) ABSTRACT

An information display control device includes a display unit, an icon display controller, and a usable data display controller. The icon display controller displays a plurality of application icons on the display unit. The usable data display controller displays a mark on the display unit in association with each of the application icons, the mark representing a data type usable in common in applications among a plurality of data types corresponding to the application icons displayed by the icon display controller.

### BACKGROUND OF THE INVENTION

1. Field of the Invention

The present invention relates to an information display control device, an information display control method, and a storage medium containing a program stored thereon.

2. Description of Related Art

Typical electronic information display control devices, such as personal computers and smart phones, can execute many applications. Such information display control devices can exchange usable data between two applications. For example, Japanese Unexamined Patent Application Publication No. 2013-58206 discloses a device that can transfer data (a data file) associated with one application to the other application through drag and drop operations by a user.

Although this conventional technique can transfer data among a plurality of applications, a user must preliminarily know whether the data can be used in designated applications or not. For example, before specific data is transferred from an application that can use multiple types of data to the other application that can use only the specific data among the multiple types of data, a user must determine the data usable in both applications in advance to avoid erroneous operations such as transmission of wrong data.

An object of the present invention is to provide an information display control device that can readily determine data usable in a plurality of applications.

### SUMMARY OF THE INVENTION

The present invention has been made in view of the circumstances described above.

An aspect of the present invention is an information display control device including: a display unit; an icon display controller that displays a plurality of application icons on the display unit; and a usable data display controller that displays a mark on the display unit in association with each of the application icons, the mark representing a data type usable in common in applications among a plurality of data types corresponding to the application icons displayed by the icon display controller.

### BRIEF DESCRIPTION OF THE DRAWINGS

FIG. 1 is a diagram illustrating the schematic configuration of a lesson support system in a first embodiment;

FIG. 2 is a block diagram illustrating the schematic configuration of a scientific calculator (a student terminal) in a first embodiment;

FIG. 3 is a block diagram illustrating the schematic configuration of another scientific calculator (a student terminal) in a first embodiment;

FIG. 4 is a block diagram illustrating the schematic configuration of a personal computer (a teacher terminal) in a first embodiment;

FIG. 5 is a list on icon information data in a first embodiment;

FIG. 6 is a flowchart illustrating a data transmitting process in a first embodiment;

FIG. 7 is a flowchart illustrating an information display control process in a first embodiment;

FIGS. 8A to 8C illustrate example display screens in an information display control process in a first embodiment;

FIGS. 9A to 9C illustrate example display screens in an information display control process in a first embodiment;

FIGS. 10A to 10C illustrate example display screens in an information display control process in a first embodiment;

FIGS. 11A and 11B illustrate example display screens in an information display control process in a first embodiment;

FIG. 12 is a plan view of a mobile terminal in a second embodiment;

FIG. 13 is a block diagram illustrating the schematic configuration of a mobile terminal in a second embodiment;

FIG. 14 is a list of icon information data in a second embodiment;

FIG. 15 is a flowchart illustrating an information display control process in a second embodiment;

FIGS. 16A to 16C each illustrate an example touch screen in an information display control process in a second embodiment;

FIGS. 17A to 17C each illustrate an example touch screen in an information display control process in a second embodiment;

FIGS. 18A to 18C each illustrate an example touch screen in an information display control process in a second embodiment; and

FIGS. 19A to 19C each illustrate an example touch screen in an information display control process in a second embodiment.

### DESCRIPTION OF THE PREFERRED EMBODIMENTS

Embodiments of the present invention will now be described in detail with reference to the accompanying drawings. The scope of the invention, however, should not be limited to the illustrated examples.

### 1 First Embodiment

In a first embodiment of the present invention, an information display control device according to the present invention is applied to a personal computer.

### [1.1 Configuration of Lesson Support System 100]

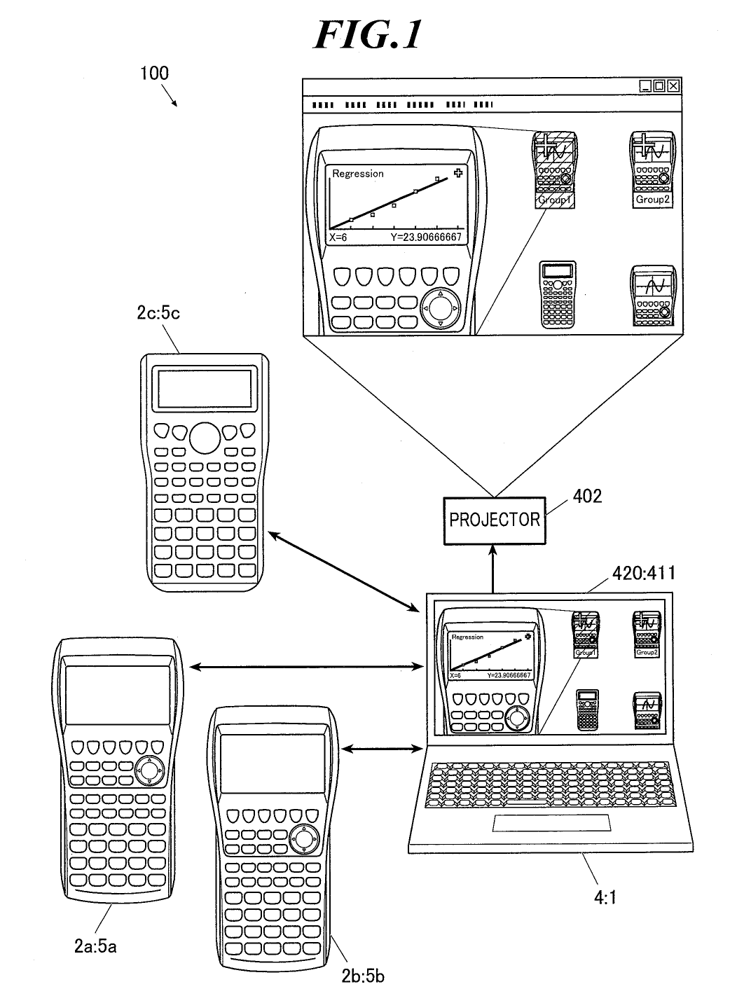

FIG. 1 illustrates the schematic configuration of a lesson support system 100 in the first embodiment.

The lesson support system 100 supports a lesson using scientific calculators and includes three scientific calculators 2a to 2c and a personal computer 4 as shown in the drawing. The scientific calculators 2a and 2b are graphic scientific calculators capable of displaying a graph, and the scientific calculator 2c is a general scientific calculator capable of calculating only a general function.

[1.2 Configuration of Scientific Calculators 2a and 2b (Student Terminals 5a and 5b)]

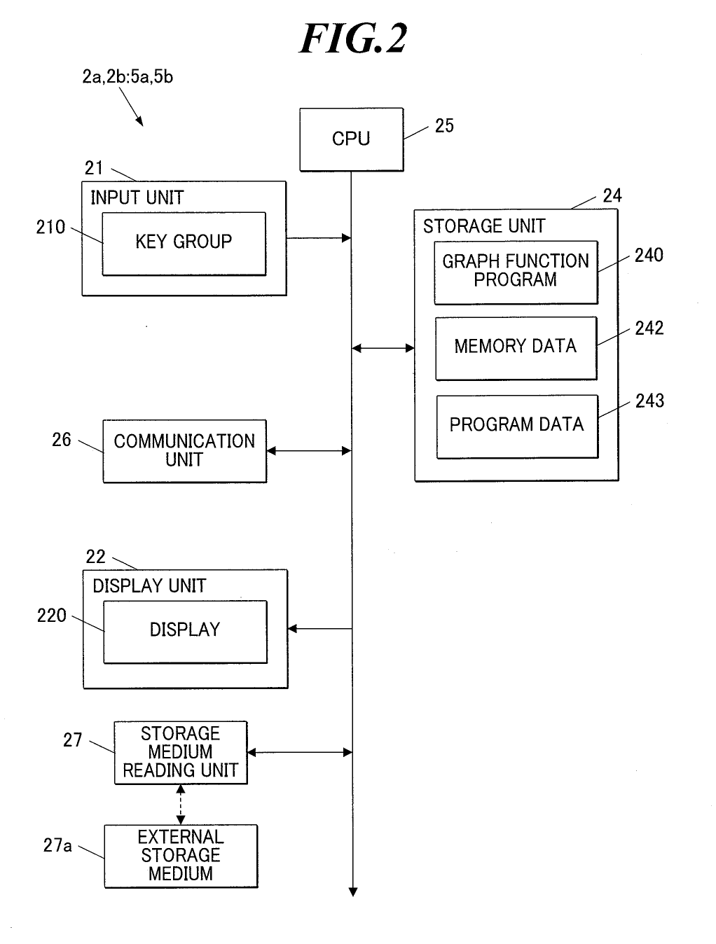

FIG. 2 is a block diagram illustrating the schematic functional configuration of scientific calculators 2a and 2b.

As shown in the drawing, the scientific calculators 2a and 2b each include a display unit 22, an input unit 21, a communication unit 26, a storage medium reading unit 27, a storage unit 24, and a central processing unit (CPU) 25.

The display unit 22 includes a display 220 capable of displaying various color information on the display 220 based on display signals from the CPU 25.

The input unit 21 includes a key group 210 and outputs a signal corresponding to the type of the pressed key to the CPU 25.

The communication unit 26 can communicate with a personal computer 4 (a teacher terminal 1 described below) and any other scientific calculator 2.

The storage medium reading unit 27 reads information from a storage medium 27a such as an SD card and records information on the storage medium 27a.

The storage unit 24 is a memory that stores programs and data for implementing various functions of the scientific calculators 2a and 2b and that functions as a work area of the CPU 25. In the first embodiment, the storage unit 24 stores a graph function program 240, memory data 242, and program data 243.

The graph function program 240 is a basic program of the scientific calculators 2a and 2b and is an application (or an application program) for calculating various functions and displaying graphs.

The memory data 242 includes setup data, data on a view window or a screen (i.e., data on a display range and a scale interval of the coordinate system), list data, data of the graph displaying range, and graph expression data.

The program data 243 includes key operation data indicating operational procedures of the key group 210.

The CPU 25 comprehensively controls individual portions of the scientific calculators 2a and 2b. Specifically, the CPU 25 deploys a system program and a specified program among various application programs stored in the storage unit 24, and performs various processes in cooperation with the deployed program.

The scientific calculators 2a and 2b are respectively used as student terminals 5 by different students during a lesson.

[1.3 Configuration of Scientific Calculator 2c (Student Terminal 5c)]

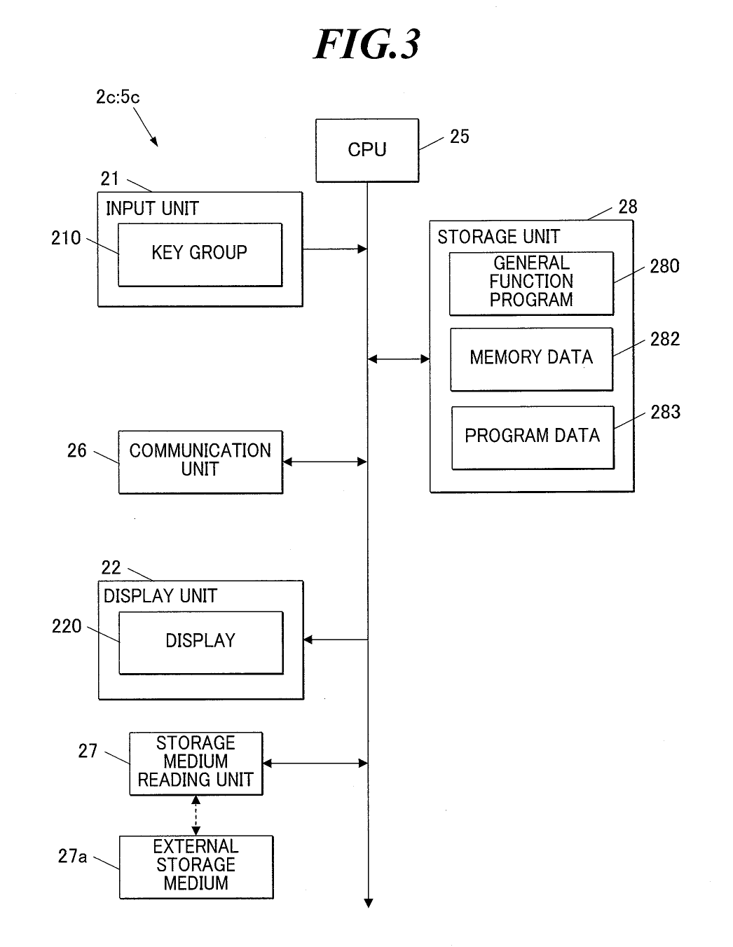

FIG. 3 is a block diagram illustrating the schematic functional configuration of a scientific calculator 2c.

As shown in the drawing, the scientific calculator 2c includes a display unit 22, an input unit 21, a communication unit 26, a storage medium reading unit 27, a storage unit 28, and a central processing unit (CPU) 25. That is, the scientific calculator 2c includes the storage unit 28 in place of the storage unit 24 in the scientific calculators 2a and 2b. Since each portion other than the storage unit 28 has the same configuration as that of the scientific calculators 2a and 2b, the redundant description on the configuration is omitted.

The storage unit 28 is a memory that stores programs and data for implementing various functions of the scientific calculator 2c and that functions as a work area of the CPU 25. In the first embodiment, the storage unit 28 stores a general function program 280, memory data 282, and program data 283.

The general function program 280 is a basic program of the scientific calculator 2c and is an application (or an application program) for calculating various functions.

The memory data 282 includes setup data and list data, for example.

The program data 283 includes key operation data indicating operational procedures of the key group 210.

The scientific calculator 2c is used as a student terminal 5 by a student other than the students using the scientific calculators 2a and 2b during a lesson.

### [1.4 Configuration of Personal Computer 4 (Teacher Terminal 1)]

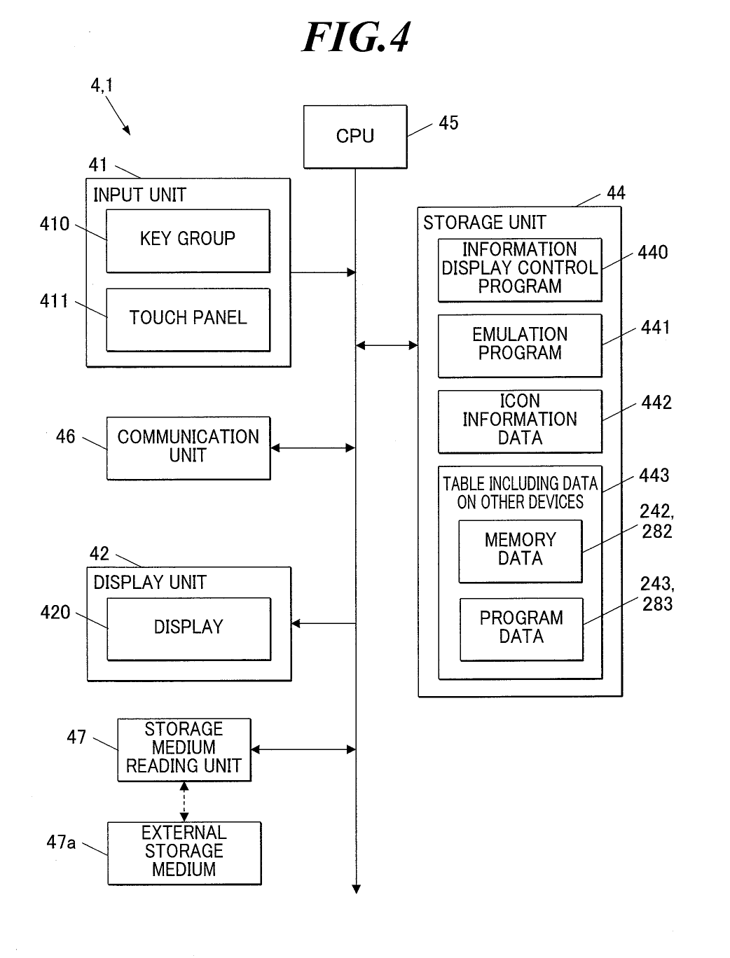

FIG. 4 is a block diagram illustrating the schematic functional configuration of a personal computer 4.

As shown in the drawing, the personal computer 4 is an information display control device according to the present invention and includes a display unit 42, an input unit 41, a storage medium reading unit 47, a communication unit 46, a storage unit 44, and a CPU 45.

The display unit 42 includes a display 420 capable of displaying various color information on the display 420 based on display signals from the CPU 45. The display 420 is integrated with a touch panel 411 and can receive touch operations by a user.

The input unit 41 includes a key group 410 and the touch panel 411 and outputs signals corresponding to the type of the pressed key and the location of the touch panel 411 to the CPU 45.

The storage medium reading unit 47 reads information from a storage medium 47a such as an SD card and records information on the storage medium 47a.

The communication unit 46 can communicate with student terminals 5 (scientific calculators 2a to 2c).

The storage unit 44 is a memory that stores programs and data for implementing various functions of the personal computer 4 and that functions as a work area of the CPU 45. In the first embodiment, the storage unit 44 stores an information display control program 440 according to the invention, an emulation program 441 and icon information data 442.

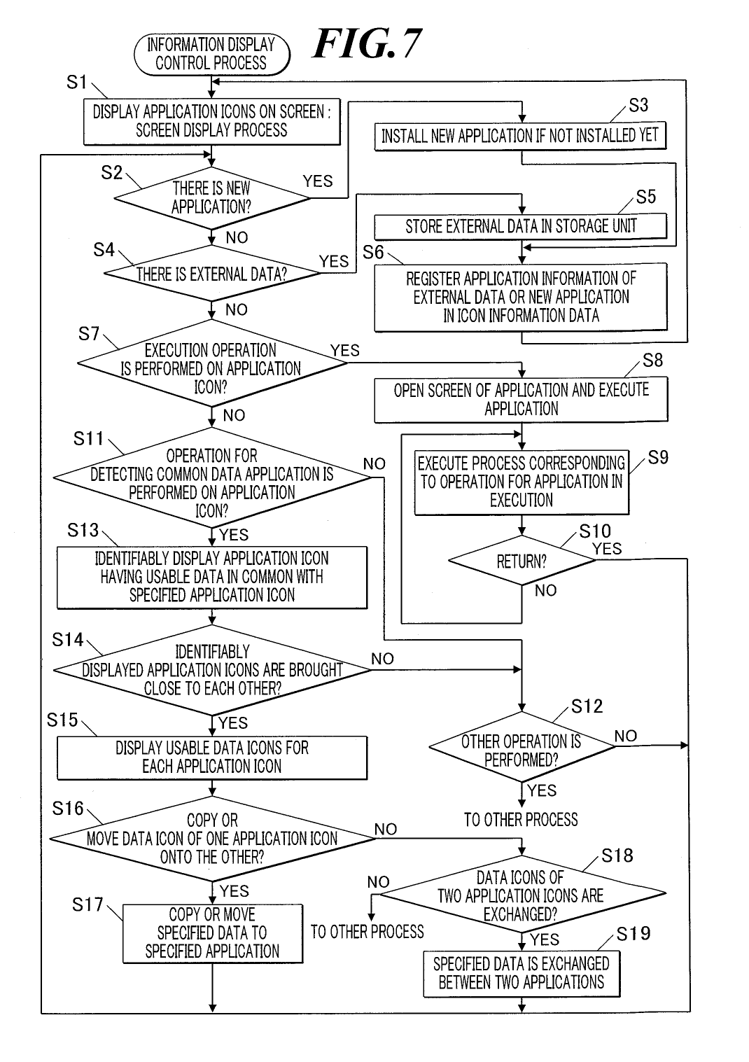

The information display control program 440 allows the CPU 45 to execute an information display control process described below (see FIG. 7). The information display control program 440 in the first embodiment can emulate the student terminal 5.

The emulation program 441 emulates the scientific calculators 2a to 2c.

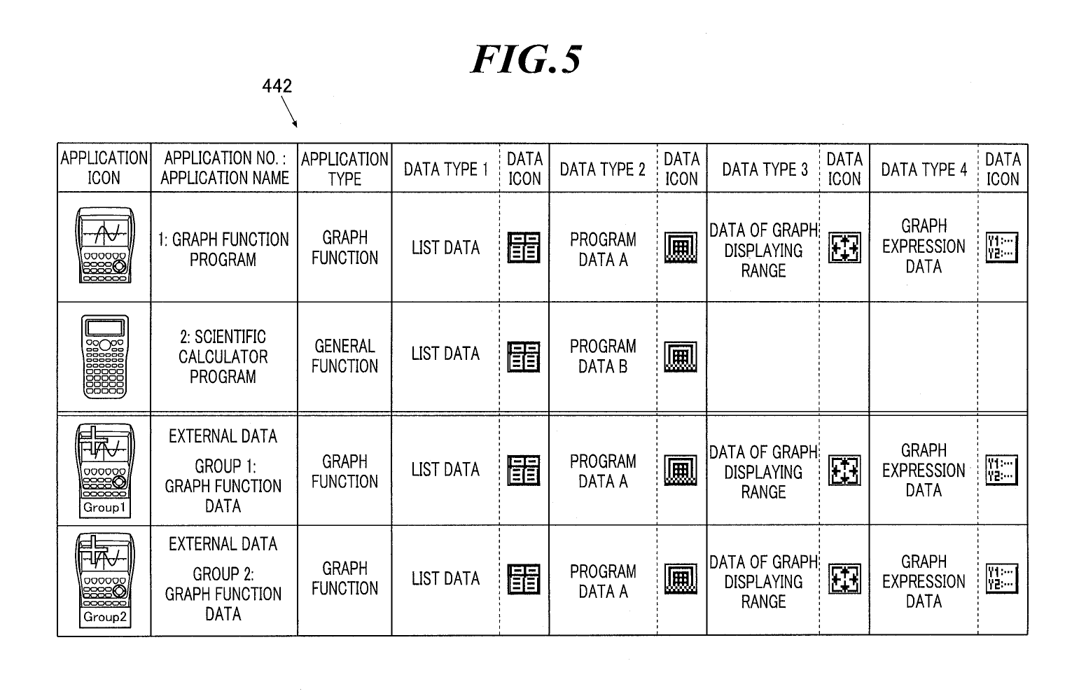

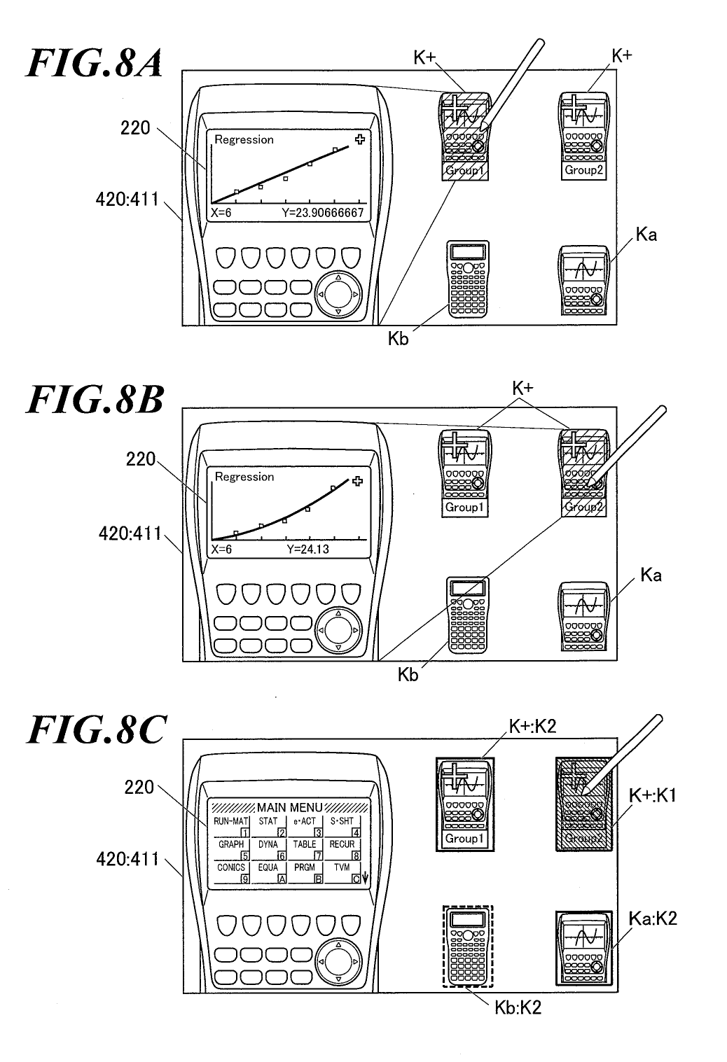

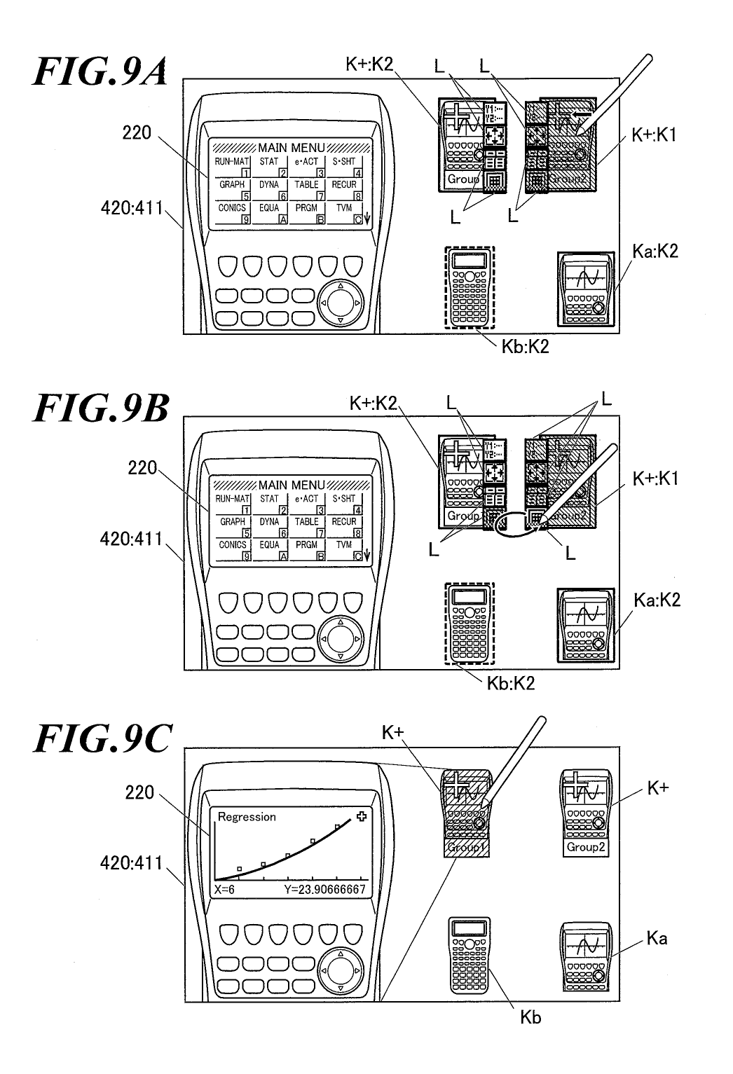

With reference to FIG. 5, the icon information data 442 includes application icons K (for example, see FIG. 8A) representing applications stored (registered) in association with various pieces of application information. The application information associated with each application icon K includes the application name, the application type, the data types of a plurality of pieces of data used in the application, and data icons L (for example, see FIG. 9A) representing the data types. In the first embodiment, an application icon K representing the graph function program 240 and an application icon K representing the general function program 280 are stored in the icon information data 442. The application icon K representing the graph function program 240 is associated with a plurality of data types including list data, program data A (program data 243), graph display range data, and graph expression data. The application icon K representing the general function program 280 is associated with a plurality of data types including list data and program data B (program data 283).

If external data transmitted from another device can be used in the application represented by any application icon K stored in the icon information data 442, the external data is stored (registered) as an application icon K+ (for example, see FIG. 8A) in the icon information data 442. The application icon K+ is associated with the same application information as an application icon K representing the application that can use the external data.

With reference to FIG. 4, the storage unit 44 has a table 443 including data of other devices which is generated for each student terminal 5 in an information display control process (see FIG. 7) described below. The table 443 including the data of other devices includes memory data 242, 282 transmitted from the corresponding student terminals 5 and program data 243, 283 in association with each other. When the student terminals 5 are emulated, the table 443 is used as their virtual storage units 24, 28.

The CPU 45 comprehensively controls individual portions of the personal computer 4. Specifically, the CPU 45 deploys a system program and a specified program among various application programs stored in the storage unit 44, and performs various processes in cooperation with the deployed program.

The personal computer 4 emulates the scientific calculators 2a to 2c when the CPU 45 executes the emulation program 441. Thus, for example, the data area of the virtual storage unit 44 of the virtual scientific calculator implemented by the emulation is formed in the storage unit 44. At this time, a screen of the display 220 and a key group 210 in the virtual scientific calculator are displayed on the display 420 (see FIG. 1).

The personal computer 4 is used as a teacher terminal 1 by a teacher during the lesson.

Now referring back to FIG. 1, the personal computer 4 is connected with a projector 402. The projector 402 enlarges and displays the screen of the display 420 of the personal computer 4. The projector 402 may be any known projector.

### [1.5 Operations of Student Terminal 5]

A data transmitting process executed by a student terminal 5 will now be described.

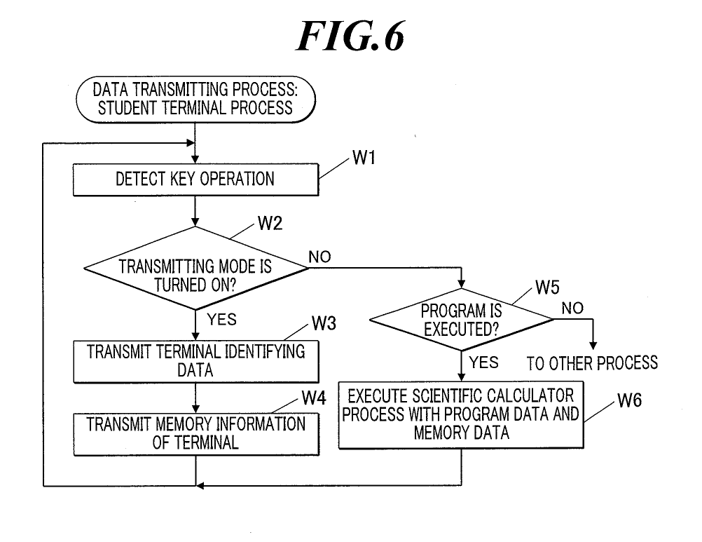

FIG. 6 is a flowchart illustrating a data transmitting process.

The CPU 25 executes the data transmitting process by deploying the data transmitting program (not shown) upon an execution instruction for the data transmitting process inputted to the student terminal 5 via the input unit 21 by a user. The data transmitting process is executed before an information display control process (see FIG. 7) described below in the teacher terminal 1.

As shown in FIG. 6, the CPU 25 detects a key operation by a user (Step W1) in the data transmitting process. The key operation may be a single key operation or may be multiple key operations.

The CPU 25 then determines whether a series of key operations detected in Step W1 is the operation for turning on an transmitting mode (i.e., for permitting transmission) of memory information (memory data 242, 282 and program data 243, 283) in its terminal (a student terminal 5) or not (Step W2).

In Step W2, if it is determined that the series of the key operations is the operation for turning on the transmitting mode of the memory information (Step W2; Yes), then the CPU 25 transmits terminal identifying data for identifying its terminal to the teacher terminal 1 via the communication unit 26 (Step W3), transmits its memory information (Step W4), and the process returns to Step W1 described above.

In Step W2, if it is determined that the operation for turning on the transmitting mode of the memory information is not performed (Step W2; No), then the CPU 25 determines whether the graph function program 240 or the general function program 280 is executed or not (Step W5). If it is determined that no program is executed (Step W5; No), then the process goes to another process.

In Step W5, if it is determined that the graph function program 240 or the general function program 280 is executed (Step W5; Yes), then the CPU 25 performs a scientific calculator process by the program data 243, 283, the memory data 242, 282 and the like (Step W6), and the process returns to Step W1 described above.

### [1.6 Operations of Teacher Terminal 1]

The information display control process executed by the teacher terminal 1 will now be described.

FIG. 7 is a flowchart illustrating the information display control process.

The CPU 45 executes the information display control process by reading the information display control program 440 from the storage unit 44 and deploying the program 440 upon an execution instruction for the information display control process inputted to the teacher terminal 1 via the input unit 41 by a user. In the first embodiment, terminal identifying data and memory information on a student terminal 5 have already been transmitted to the teacher terminal 1 by the above-mentioned data transmitting process.

With reference to FIG. 7, in the information display control process, the CPU 45 performs a screen display process for displaying various application icons K (for example, see FIG. 8A) on the display 420 (Step S1). In Step S1, the CPU 45 reads icon information data 442 from the storage unit 44 to display the application icons K (including application icons K+ of external data) registered in the icon information data 442.

In the first embodiment, in the screen display process, the CPU 45 emulates student terminals 5, whose terminal identifying data has been transmitted to the teacher terminal 1, and displays the application icons K of virtual applications implemented by the emulation on the display 420.

Specifically, the CPU 45 generates a table 443 including the data on other devices corresponding to the terminal identifying data as a virtual data area of virtual student terminals 5 implemented by the emulation in the storage unit 44, receives memory data 242, 282 and program data 243, 283 stored in the storage units 24, 28 of the student terminals 5 whose terminal identifying data has been transmitted to the teacher terminal 1, and stores the memory data 242, 282 and the program data 243, 283 in the table 443 including the data of other devices. This allows the CPU 45 to execute the graph function program 240 and the general function program 280 of the student terminals 5 as virtual applications.

The CPU 45 displays the application icons K of the graph function program 240 and the general function program 280 preregistered in the icon information data 442 (or registered at the time of the emulation) on the display 420. At this time, the CPU 45 registers the terminal identifying data in the icon information data 442 in association with the application icons K, and displays the display 220 and the key group 210 of a virtual student terminal 5 on the display 420.

The CPU 45 then determines whether there is a new application that is not registered in the icon information data 442 or not (Step S2). If it is determined that there is a new application (Step S2; Yes), then the new application is installed if the new application has not been installed yet (Step S3), and the process goes to Step S6 described below.

In Step S2, if it is determined that there is no new application (Step S2; No), then the CPU 45 determines whether there is external data transmitted from an external device or not (Step S4). The external data can be used in any application registered in the icon information data 442.

In Step S4, if it is determined that there is external data (Step S4; Yes), then the CPU 45 stores the external data in the storage unit 44 (Step S5).

The CPU 45 then registers the external data or the application information of the new application in the icon information data 442 (Step S6), and the process returns to Step S1 described above. Note that the application information includes the application name (or the external-data name), application icon K, the application type, and the data types and their data icons L. If there is newly registered data having a data type that differs only in data format and detailed content from the type of registered data, then the CPU 45 adds different indexes (e.g., A, B, . . . ) to the data icons L to indicate that data conversion is required for the data to be used for each other's application.

In Step S4, if it is determined that there is no external data (Step S4; No), then the CPU 45 determines whether an execution operation (e.g., double tapping) of the application is performed on the application icon K by a user or not (Step S7).

In step S7, if it is determined that an execution operation is performed on the application icon K (Step S7; Yes), then the CPU 45 opens the screen of the application represented by the application icon K to execute the application (Step S8). At this time, the CPU 45 displays the application icon K in a display mode indicating that the application is being executed.

The CPU 45 then receives various operations on the application that is being executed by a user and performs processes corresponding to them (Step S9), and then determines whether the application execution state is ended according to a user operation or not (Step S10). If the CPU 45 determines that the application execution state is not ended (i.e., the state is maintained) (Step S10; No), then the process returns to Step S9. If it is determined that the state is ended (Step S10; Yes), then the process returns to Step S2.

In Step S7, if it is determined that no operation for executing the application is performed on the application icon K (Step S7; No), then the CPU 45 determines whether an operation for detecting a common data application is performed on the application icon K by a user or not (Step S11). The operation for detecting the common data application is an operation for detecting an application having usable data in common with the application specified by a user, and is, for example, an operation such that a user touches any application icon K for a predetermined time (e.g., two seconds) or more.

In Step S11, if it is determined that no operation for detecting the common data application is performed by a user (Step S11; No), then the CPU 45 determines whether another operation is performed by a user or not (Step S12). If it is determined that another operation is performed (Step S12; Yes), then the CPU 45 executes the process in accordance with the operation. If it is determined that another operation is not performed (Step S12; No), then the process returns to Step S2.

In Step S11, if it is determined that the operation for detecting the common data application is performed on the application icon K by a user (Step S11; Yes), then the CPU 45 detects and identifiably displays the application having usable data in common with the application of the application icon K specified by a user (hereinafter, referred to as “a specified application icon K1” (for example, see FIG. 8C)) (Step S13).

Specifically, the CPU 45 detects the data types usable in common in the application of the specified application icon K1 and other applications, from the multiple data types corresponding to the application icons K displayed on the display 420 based on the icon information data 442 read from the storage unit 44. That is, the CPU 45 detects an application icons (hereinafter, referred to as “corresponding application icons K2” (for example, see FIG. 8C)) of the applications having usable data types in common with the application of the specified application icon K1, among all the application icons K except the specified application icon K1 from the icon information data 442.

The CPU 45 then identifiably displays the specified application icon K1 and the corresponding application icons K2 individually. The identifiable display only needs to distinguish the specified application icon K1, the corresponding application icons K2; and the application icons K other than the icons K1 and K2 and an example of the identifiable display includes surrounding the specified application icon K1 and the corresponding application icons K2 with frames of different colors.

At this time, the CPU 45 further identifiably displays a corresponding application icon K2, for which the data type are completely shared with the application of the specified application icon K1 (are used in common), and a corresponding application icon K2, for which the data types are only partially shared with the application of the specified application icon K1, among the corresponding application icons K2. An example of the identifiable display includes surrounding the corresponding application icon K2, for which the data type are completely shared with the application of the specified application icon K1, with a solid color frame; and surrounding the corresponding application icon K2, for which the data types are only partially shared with the application of the specified application icon K1, with a dashed color frame.

The CPU 45 then determines whether the specified application icon K1 and a corresponding application icon K2 displayed on the display 420 are brought close to each other according to a user operation or not (Step S14). If it is determined that they are not brought close to each other (Step S14; No), then the process goes to Step S12.

In Step S14, if it is determined that the specified application icon K1 and a corresponding application icon K2 are brought close to each other (Step S14; Yes), then the CPU 45 displays the data icons L (see FIG. 9A) corresponding to the data types detected in Step S13 in association with each of the application icons K on the display 420 (Step S15). Specifically, the CPU 45 retrieves the data icons L corresponding to the data types usable in both of the applications from the icon information data 442 and displays them in association with each of the specified application icon K1 and the corresponding application icon K2.

At this time, the CPU 45 identifiably displays the data icons L in the same manner as the corresponding application icon K (the specified application icon K1 or the corresponding application icon K2). Additionally, the CPU 45 distinguishably displays the data icon L representing the data type that requires conversion of the data format for use in another application from the data icon L representing the data type that does not require such a conversion.

The CPU 45 then determines whether a data icon L associated with one of the application icons K (i.e., one of the specified application icon K1 and the corresponding application icon K2) is moved onto the other of the application icons K (i.e., the other of the specified application icon K1 and the corresponding application icon K2) according to a user operation (Step S16).

In Step S16, if it is determined that a data icon L associated with one of the application icons K is moved onto the other of the application icons K (Step S16; Yes), then the CPU 45 moves or copies the data of the data type corresponding to the data icon L to the application represented by the other application icon K and allows the data to be used in the application data (Step S17). The process then returns to Step S2.

At this time, the CPU 45 determines whether to move or copy the data according to the moving operation of the data icon L by a user. If the data is moved, then the data is eliminated from the source application. If the data corresponding to the moved data icon L requires conversion of its data format when used in the destination application, the data format is converted by the CPU 45 to be used in the destination application.

In Step S16, if it is determined that a data icon L associated with one application icon K is not moved onto the other application icon K (Step S16; No), then the CPU 45 determines whether the data icons L, which are of the same type, respectively associated with the two application icons K (the specified application icon K1 and the corresponding application icon K2) are exchanged according to a user operation or not (Step S18).

In Step S18, if it is determined that the data icons L associated with the two application icons K are not exchanged (Step S18; No), then the CPU 45 goes to another process.

In Step S18, if it is determined that the data icons L associated with the two application icons K are exchanged (Step S18; Yes), then the CPU 45 exchanges the data of the data types corresponding to the data icons L between the two applications represented by the two application icons K (Step S19). The process then returns to Step S2.

### [1.7 Example of Operation of Teacher Terminal 1]

An operation of the teacher terminal 1 described above will now be described with specific examples.

FIGS. 8A to 11B illustrate example display screens on a display 420 in an information display control process described above.

When a user performs an information display control process through a predetermined operation, a student terminal 5 is emulated. An application icon K of a virtual application implemented by the emulation appears on the display 420 (Step S1). Specifically, an application icon Ka representing the graph function program 240 and an application icon Kb representing the general function program 280 are displayed. At this time, the display 220 of the virtual student terminal 5 by the emulation is also displayed on the display 420.

If external data of the graph function program 240 is transmitted by the above-mentioned data transmitting process from the two student terminals 5a and 5b (Step S2; No, Step S4; Yes), then the external data is stored in a storage unit 44 (Step S5) and the application information on the external data is registered in icon information data 442 (Step S6). Specifically, an application icon in group 1 labeled with “+” indicating the external data on the graph scientific calculator of the student terminal 5a, the application type “graph function”, the data type 1 “list data”, the data type 2 “program data type A”, the data type 3 “data of the graph displaying range”, and the data type 4 “graph expression data”; and an application icon in group 2 labeled with “+” indicating the external data on the graph scientific calculator of the student terminal 5b, the application type “graph function”, the data type 1 “list data”, the data type 2 “program data type A”, the data type 3 “data of the graph displaying range”, and the data type 4 “graph expression data” are registered in the icon information data 442. The data icons associated with the respective data types are registered.

The external data transmitted from the student terminals 5a and 5b includes different list data (numeric data) and program data. In addition, the program data from the student terminal 5a is a primary regression expression and the program data from the student terminal 5b is a quadratic regression expression.

The two application icons K+ of the external data newly registered in the icon information data 442 appear on the display 420 (Step S1). Each of the two application icons K+ is a combination of the application icon Ka representing the graph function program 240, a symbol “+” representing external data, and a symbol “Group 1” or “Group 2” representing a student terminal 5a or 5b.

With reference to FIG. 8A, if a user performs an execution operation of the application through double tapping of the application icon K+ in group 1 with a touch pen (Step S2; No, Step S4; No, Step S7; Yes), then the application icon K+ is displayed in a specified state, and the graph function program 240, which is a virtual application, is executed (Step S8). If a user performs the graph displaying function through a predetermined operation, then a graph of a primary regression expression based on the list data, the program data, the data of the graph displaying range, and the graph expression data corresponding to the application icon K+ in group 1 appear on the display 220 in the virtual student terminal 5 on the display 420 (Step S9).

With reference to FIG. 8B, if a user performs an execution operation of the application through double tapping of the application icon K+ in group 2, instead of group 1 (Step S2; No, Step S4; No, Step S7; Yes), then the application icon K+ is displayed in a specified state, and the graph function program 240, which is a virtual application, is executed (Step S8). If a user performs the graph displaying function through a predetermined operation, then a graph of a quadratic regression expression based on the list data, the program data, the data of the graph displaying range, and the graph expression data corresponding to the application icon K+ in group 2 appear on the display 220 in the virtual student terminal 5 on the display 420 (Step S9).

With reference to FIG. 8C, if a user performs an operation for detecting the common data application through touching the application icon K+ in group 2 for two seconds or more (Step S10; Yes, Step S2; No, Step S4; No, Step S7; No, Step S11; Yes), then the colored application icon K+ is displayed as the specified application icon K1, and the other three application icons K are detected as the corresponding application icons K2 based on the icon information data 442 and are surrounded by color frames having a color different from that of the specified application icon K1 (Step S13). Specifically, data types 1 to 4 for each of the application icons are determined based on the icon information data 442, and the application icons including common data types are detected as the application icons including common data, and displayed with color or displayed with different color frames.

At this time, the application icon K+ in group 2 and the application icon Ka representing the graph function program 240 in the corresponding application icons K2 are surrounded by a solid color frame indicating that the data types are completely common with those of the specified application icons K1, and the application icon Kb representing the general function program 280 is surrounded by a dashed color frame indicating that the data types are partially common with those of the specified application icon K1. Specifically, the application icon Ka of the graph function program includes data types 1, 2, 3, and 4 based on the icon information data 442, and the application icon Kb of the general function program 280 includes data types 1 and 2. Only a part of the data types, i.e., the data types 1 and 2, is common, and thus the application icon Kb is surrounded by a dashed color frame.

With reference to FIG. 9A, if the specified application icon K1 is brought close to the corresponding application icon K2 (the application icon K+ in group 2) through a drag operation by a user (Step S14; Yes), then multiple data icons L corresponding to multiple data types usable in both of the applications are read from the icon information data 442, and are displayed such that the data icons L are partly overlapped with the adjacent sides of the two application icons K (Step S15). At this time, the multiple data icons L displayed on each of the application icons K correspond to the graph expression data, the data of the graph displaying range, the list data, and the program data (see FIG. 5). In addition, each of the data icons L is identifiably displayed in the same manner as the corresponding application icon K. That is, each of the data icons L associated with the specified application icon K1 is displayed with color and each of the data icons L associated with the corresponding application icon K2 is surrounded by a solid color frame.

With reference to FIG. 9B, if a user traces the screen to make a round trip between the data icons L of the program data displayed on the two respective application icons K (Step S16; No, Step S18; Yes), then the program data is exchanged between the two applications represented by the two application icons K (Step S19).

With reference to FIG. 9C, if a user performs an execution operation of the application through double tapping on the application icon K+ in group 1 (Step S2 No, Step S4; No, Step S7; Yes), then the identifiable display of the specified application icon K1 and the corresponding application icon K2 are eliminated together with the data icons L, the application icon K+ in group 1 is displayed in a specified state, and the graph function program 240 is executed (Step S8). When a user performs the graph displaying function through the predetermined operation, a graph of a quadratic regression expression, maintaining the original list data, is displayed because the program data has been exchanged between the graph function program 240 in group 1 and the graph function program 240 in group 2 by the operation described above (Step S9).

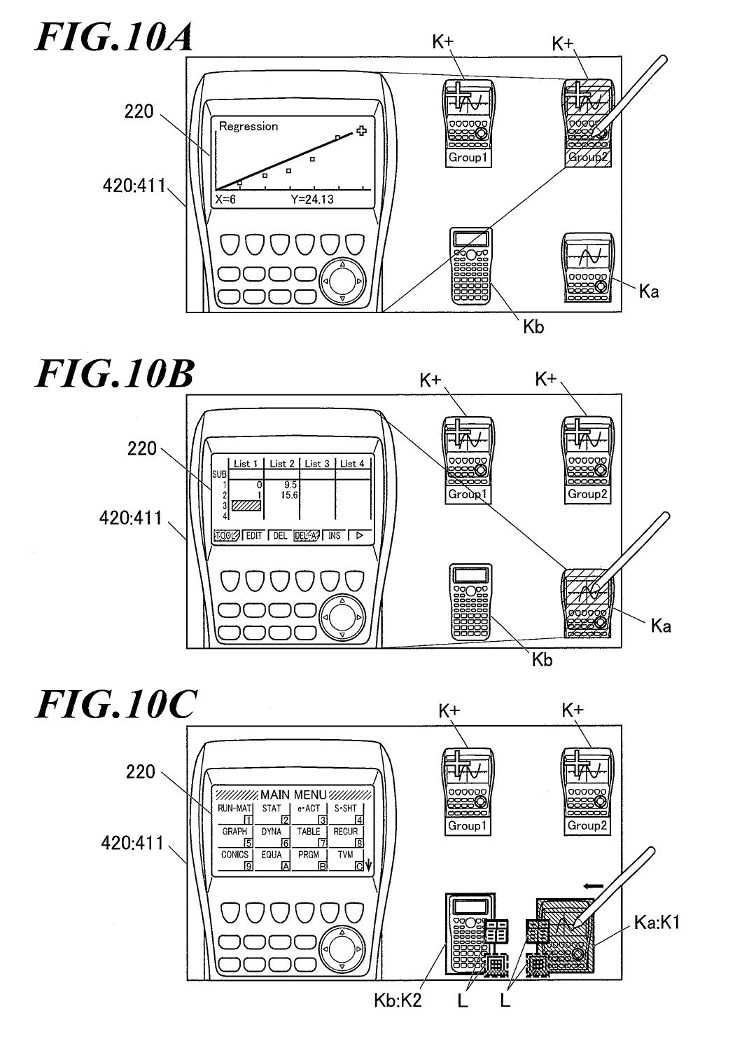

With reference to FIG. 10A, if the use performs an execution operation of the application through double tapping of the application icon K+ in group 2, instead of group 1 (Step S2; No, Step S4; No, Step S7; Yes), then the graph function program 240 is executed similarly (Step S8), and if the graph displaying function is executed, then a graph of a primary regression expression, maintaining the original list data, is displayed (Step S9).

With reference to FIG. 10B, if a user performs an execution operation of the application through double tapping of the application icon Ka representing the graph function program 240 (Step S10; Yes, Step S2; No, Step S4; No, Step S7; Yes), then the application icon Ka is displayed in a specified state, and the graph function program 240 is executed (Step S8). If a user executes a function of displaying list data through a predetermined operation, then the list data corresponding to the application icon Ka appears on the display 220 in the virtual student terminal 5 on the display 420 (Step S9).

If a user performs an operation for detecting the common data application through touching the application icon Ka for two seconds or more (Step S10; Yes, Step S2; No, Step S4; No, Step S7; No, Step S11; Yes), then the color application icon Ka is displayed as the specified application icon K1, and the application icon Kb is detected based on the icon information data 442 as the corresponding application icon K2 and is surrounded by a color frame having a color different from that of the specified application icon K1 (Step S13).

With reference to FIG. 10C, if the specified application icon K1 is brought close to the corresponding application icon K2 through a drag operation by a user (Step S14; Yes), then multiple data icons L corresponding to multiple data types usable in both of the applications are read from the icon information data 442 and appear on adjacent sides of the two application icons K (Step S15). At this time, the multiple data icons L displayed on each of the application icons K correspond to the list data and the program data (see FIG. 5). In addition, the data icons L are identifiably displayed in the same manner as the corresponding application icon K. The data icons L of the program data, however, require a conversion of the data format to use the program data in the mutual applications, and thus are surrounded by dashed color frames in contrast to the data icons L of the list data. Specifically, based on the icon information data 442, data type 2 of the application icon Ka of the graph function program 240 is “program data type A” and data type 2 of the application icon Kb of the general function program 280 is “program data type B”, and thus it is determined that a conversion of the data format is needed to use the program data and then the application icons Ka and Kb are surrounded by dashed color frames.

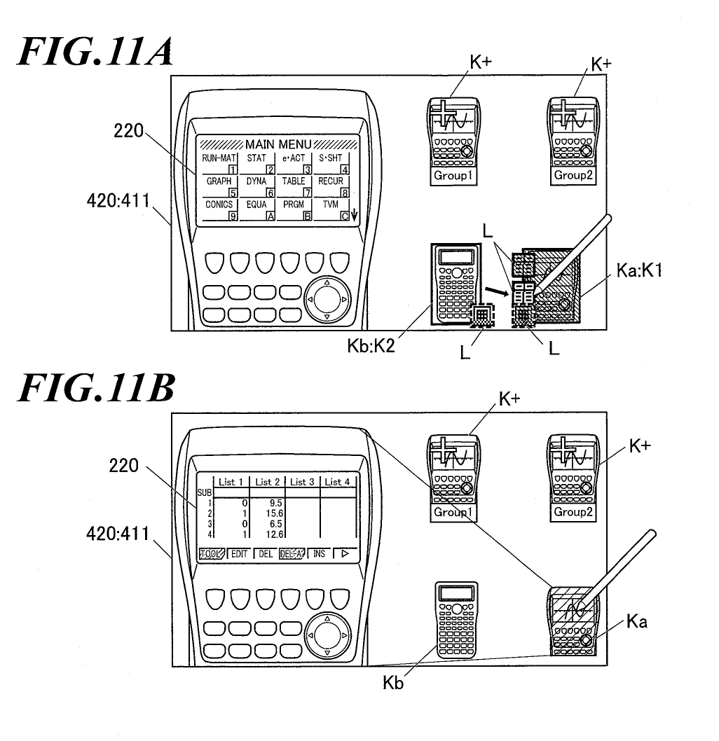

With reference to FIG. 11A, if a user long touches the data icon L of the list data associated with the corresponding application icon K2 on the corresponding application icon K2 and moves the data icon L onto the specified application icon K1 (Step S16; Yes), then the list data associated with the corresponding application icon K2 is moved to the application represented by the specified application icon K1 (Step S17).

With reference to FIG. 11B, if a user performs an execution operation of the application through double tapping of the specified application icon K1 (the application icon Ka) (Step S2; No, Step S4; No, Step S7; Yes), then the identifiable display of the specified application icon K1 and the corresponding application icon K2 are eliminated together with the data icons L, the application icon Ka is displayed in a specified state, and the graph function program 240 is executed (Step S8). When a user executes the function of displaying the list data through a predetermined operation, then the list data, to which the original list data of the application icon Kb has been added, appears as the list data of the application icon Ka (Step S9) because the original list data of the application icon Kb has been moved to the application of the application icon Ka through the operation described above.

In the first embodiment, as shown in Steps S13 to S15 in FIG. 7, FIGS. 9A to 9C, and FIGS. 10A to 10C, the data types usable in common by applications among the multiple data types corresponding to the application icons K displayed on the display 420 are detected based on the icon information data 442, and the data icons L representing the detected data types are displayed in association with each of the multiple application icons K. The user, therefore, can readily determine data (data types) usable in common in a plurality of applications by just looking at the data icons L associated with the application icons K.

As shown in Steps S16 to S19 in FIG. 7, FIGS. 9A to 9C, and FIGS. 11A and 11B, if a data icon L associated with a first application icon K is moved onto a second application icon K according to a user operation, then the data of the data type corresponding to the data icon L can be used in the application of the second application icon K. The user, therefore, can readily determine whether the data can be used in another application or not and can readily move, copy, and exchange the data by a simple operation such as mere movement of the data icon L.

As shown in Step S13 in FIG. 7, FIGS. 8A to 8C, and FIGS. 10A to 10C, the specified application icon K1 that has been specified by a user and the corresponding application icon K2 of the application having a usable data type in common with the application of the specified application icon K1 are identifiably displayed, and thereby a user can readily identify the application that has data compatibility with a user-specified application.

As shown in Step S15 in FIG. 7, and FIGS. 10A to 10C, a data icon L representing the data type that requires conversion of the data format to be used in another application is distinguishably displayed from a data icon L representing the data type that does not require the conversion, and thereby a user can readily determine whether the data conversion is needed or not in the movement of the data.

In addition, as shown in Step S17 in FIG. 7, when a data icon L is moved onto the application icon K of another application according to a user operation, the data conversion is performed for the data corresponding to the data icon L, if needed, and thereby a user can move the data without considering the need for the data conversion.

### 2 Second Embodiment

A second embodiment of the present invention will now be described in detail. In the second embodiment, an information display control device according to the present invention is applied to a mobile terminal (a smartphone).

### [2.1 Configuration of Mobile Terminal 6]

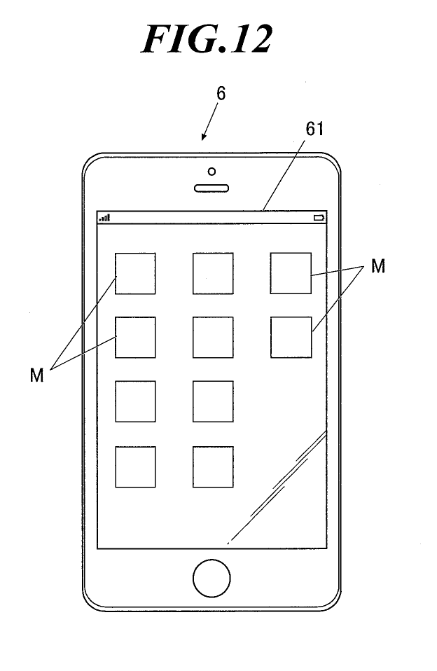

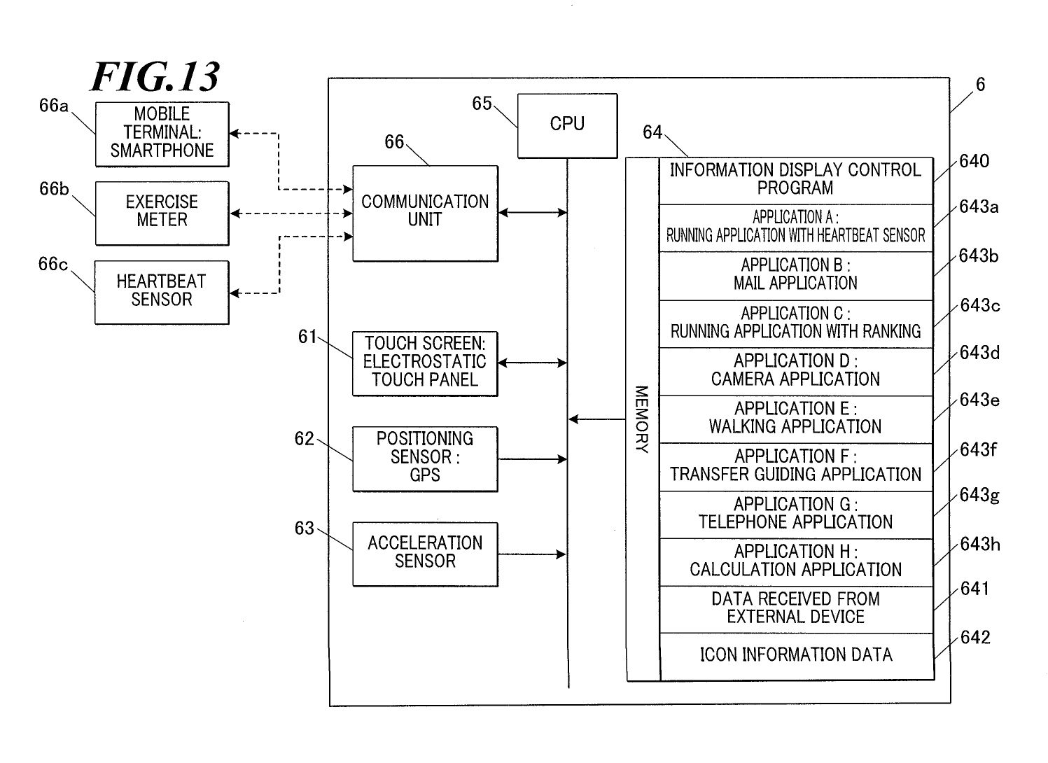

FIG. 12 is a plan view of a mobile terminal 6 in the second embodiment and FIG. 13 is a block diagram illustrating the schematic functional configuration of the mobile terminal 6.

With reference to FIG. 12, the mobile terminal 6 has a substantially flat shape and can obtain information such as a movement distance and a movement track when a user carries the mobile terminal 6 by, for example, fixing it on his/her arm or put it in his/her pocket.

Specifically, with reference to FIG. 13, the mobile terminal 6 is an information display control device according to the present invention and includes a touch screen 61, a positioning sensor 62, an acceleration sensor 63, a communication unit 66, a memory 64, and a CPU 65.

The touch screen 61 is an electrostatic touch panel. The touch screen 61 displays a key group for inputting characters or the like, outputs a signal corresponding to the type or the position of the pressed key to the CPU 65, and displays various pieces of information based on display signals input from the CPU 65.

The positioning sensor 62 is a global positioning system (GPS) sensor. The positioning sensor 62 is set to ON (an operational state) in response to a command from the CPU 65 or a user operation to perform a sensing operation.

The acceleration sensor 63 resolves the acceleration applied to the mobile terminal 6 into three axial components. The acceleration sensor 63 is also set to ON (an operational state) in response to a command from the CPU 65 or a user operation to perform a sensing operation.

The communication unit 66 provides data communications with communicable external devices (e.g., another mobile terminal 66a, an exercise meter 66b, and a heartbeat sensor 66c) through any wireless communication scheme, such as, a network, Wi-Fi, or Bluetooth™ communication scheme.

The memory 64 stores programs and data for implementing various functions of the mobile terminal 6 and functions as a work area of the CPU 65. In the second embodiment, the memory 64 stores an information display control program 640 according to the invention, data 641 received from an external device, multiple applications 643, and icon information data 642.

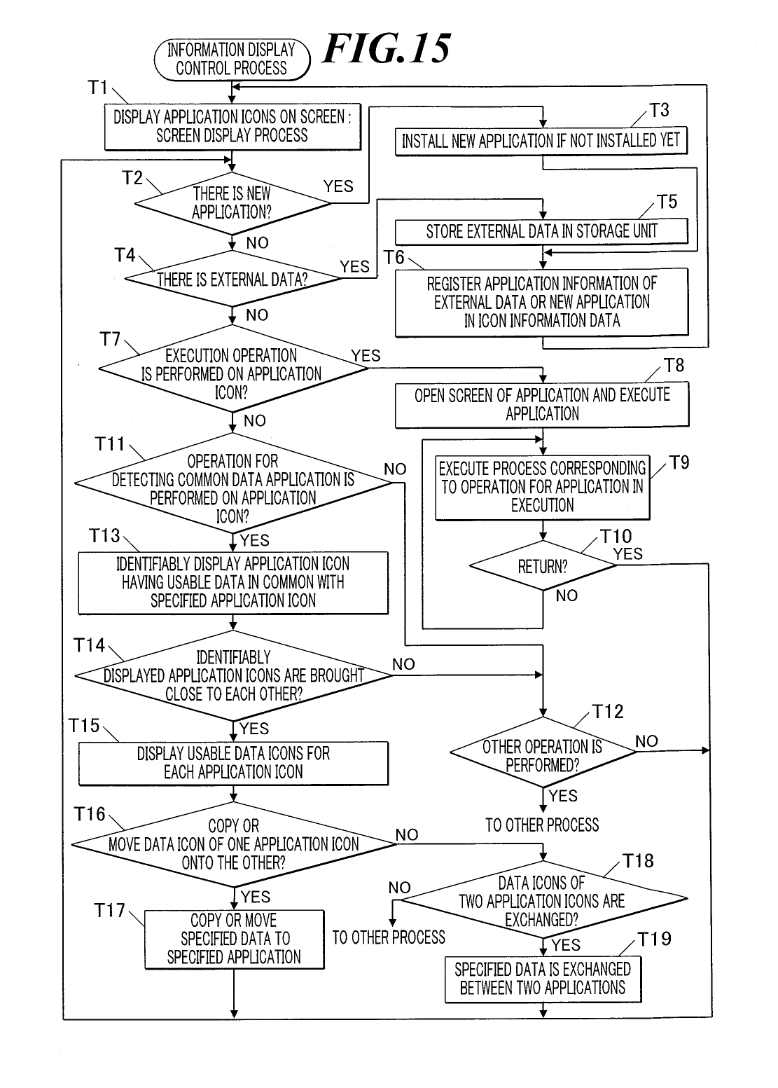

The information display control program 640 allows the CPU 65 to execute an information display control process described below (see FIG. 15). The information display control process is the same process as that in the first embodiment.

The data 641 is the data received from an external device through the communication unit 66.

The multiple applications 643 are installed in the memory 64 through presetting or downloading. In the second embodiment, the installed applications 643 include application A (a running application with a heartbeat sensor) 643a, application B (a mail application) 643b, application C (a running application with ranking) 643c, application D (a camera application) 643d, application E (a walking application) 643e, application F (a transfer guiding application) 643f, application G (a telephone application) 643g, and application H (a calculation application) 643h.

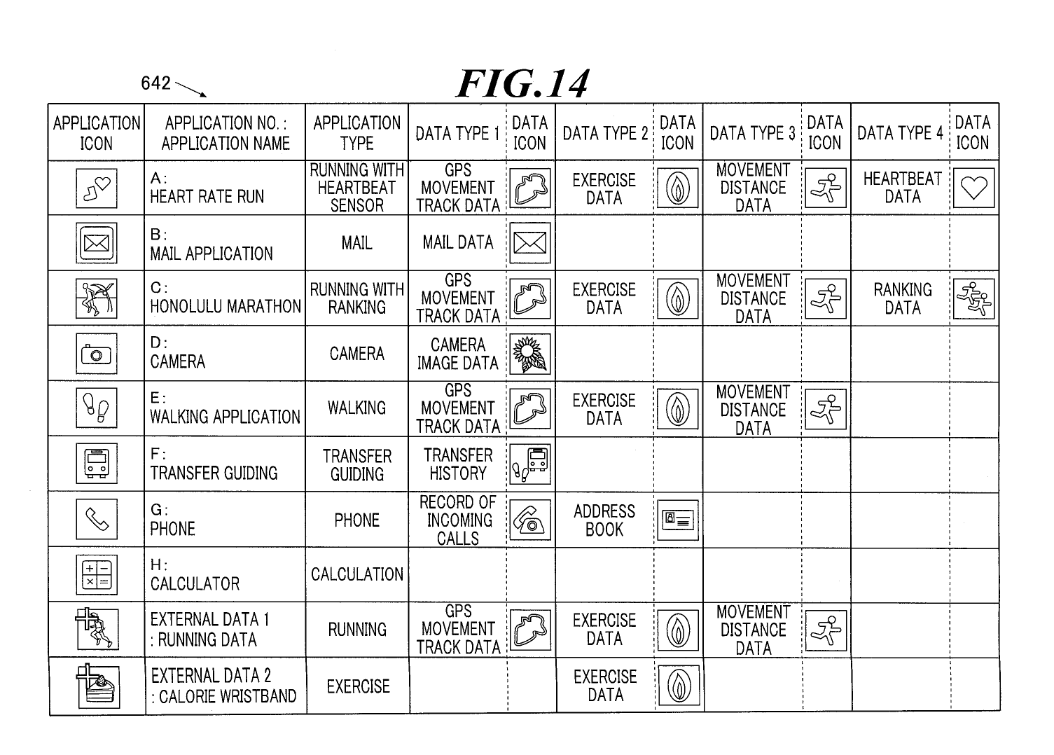

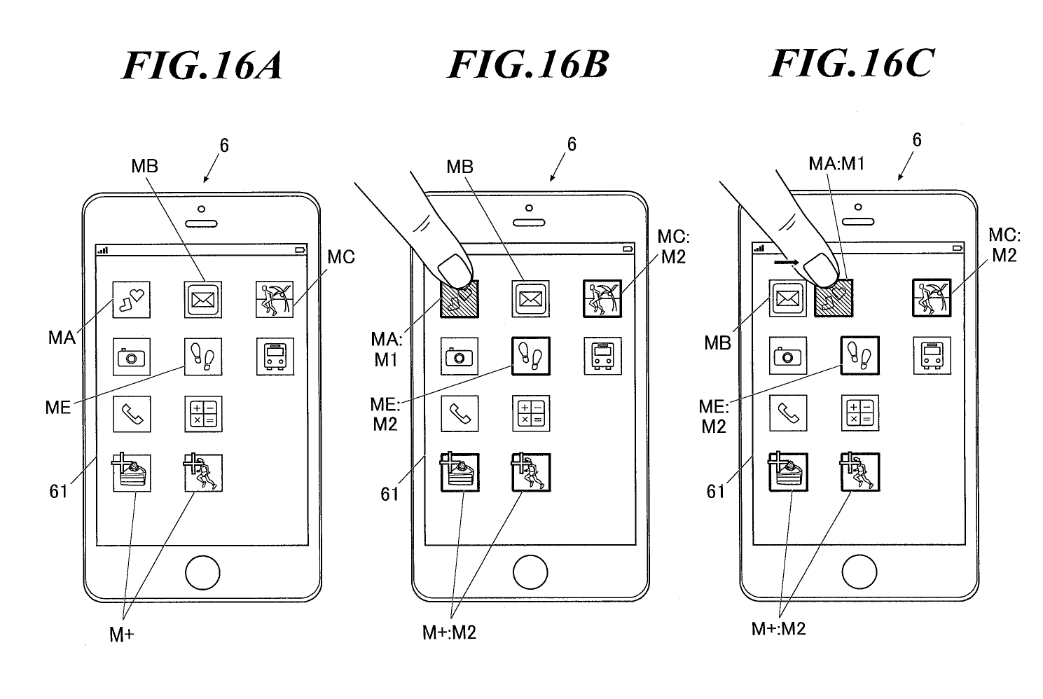

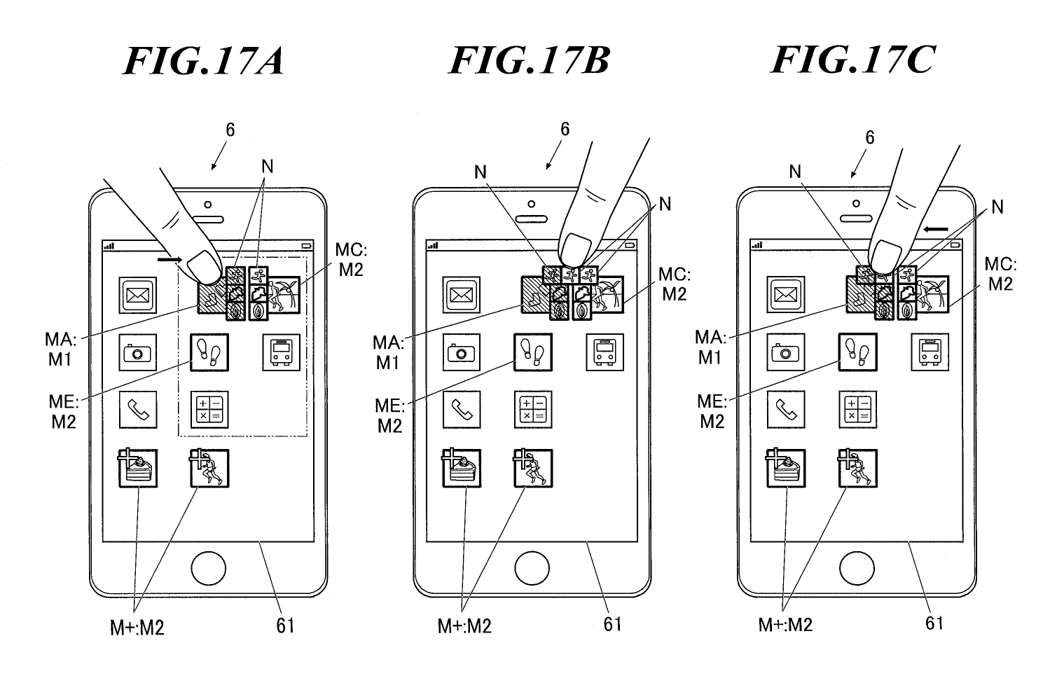

With reference to FIG. 14, the icon information data 642 includes application icons M (for example, see FIG. 16A) representing applications stored (registered) in association with various pieces of application information. The application information associated with each application icon M includes the application name, the application type, the data types of a plurality of pieces of data used in the application, and data icons N (for example, see FIG. 17A) representing the data types. In the second embodiment, icons for the application A (a running application with a heartbeat sensor) 643a to the application H (a calculation application) 643h are stored in the icon information data 642 as application icons M. Each of the application icons M representing, for example, the application A (a running application with a heartbeat sensor) 643a and the application C (a running application with ranking) 643c is associated with multiple data types including GPS movement track data, exercise data, movement distance data, and heartbeat data.

If external data transmitted from an external device can be used in the application represented by any application icon M stored in the icon information data 642, then the external data is stored (registered) as application icons M+ (for example, see FIG. 16A) in the icon information data 642. The application icons M+ are associated with application information similarly to the application icons M representing the applications that can use the external data.

The CPU 65 comprehensively controls individual portions of the mobile terminal 6. Specifically, the CPU 65 deploys a system program and a specified program among various application programs stored in the memory 64, and performs various processes in cooperation with the deployed program.

### [2.2 Operations of Mobile Terminal 6]

An information display control process executed by a mobile terminal 6 will now be described.

FIG. 15 is a flowchart illustrating the information display control process.

The CPU 65 performs the information display control process by reading the information display control program 640 from the memory 64 and deploying the program 640 upon an execution instruction of the information display control process inputted to the mobile terminal 6 according to a user operation.

With reference to FIG. 15, in the information display control process, the CPU 65 performs a screen display process for displaying various application icons M (for example, see FIG. 16A) on the touch screen 61 (Step T1). In Step T1, the CPU 65 reads the icon information data 642 from the memory 64 to display the application icons M (including application icons M+ of external data) registered in the icon information data 642.

The CPU 65 then determines whether there is a new application that is not registered in the icon information data 642 or not (Step T2). If it is determined that there is a new application (Step T2; Yes), then the new application is installed if it has not been installed yet (Step T3), and the process goes to Step T6 described below.

In Step T2, if it is determined that there is no new application (Step T2; No), then the CPU 65 determines whether there is external data transmitted from an external device or not (Step T4). The external data is the data usable in an application registered in the icon information data 642.

In Step T4, if it is determined that there is external data (Step T4; Yes), then the CPU 65 stores the external data in the memory 64 (Step T5).

The CPU 65 then registers the external data or the application information of the new application in the icon information data 642 (Step T6), and the process returns to Step T1. Note that the application information includes the application name (or the external-data name), application icon M, the application type, and the data types and their data icons N. If there is newly registered data having a data type that differs only in data format and detailed content from the type of registered data, then the CPU 65 adds different indexes (e.g., A, B,) to the data icons N to indicate that data conversion is required for the data to be used for each other's application.

In Step T4, if it is determined that there is no external data (Step T4; No), then the CPU 65 determines whether an execution operation (e.g., double tapping) of the application is performed on the application icon M by a user or not (Step T7).

In step T7, if it is determined that an execution operation is performed on the application icon M (Step T7; Yes), then the CPU 65 opens the screen of the application represented by the application icon M to execute the application (Step T8). At this time, the CPU 65 displays the application icon M in a display mode indicating that the application is being executed.

The CPU 65 then receives various operations on the application that is being executed by a user and performs processes corresponding to them (Step T9), and then determines whether the application execution state is ended according to a user operation or not (Step T10). If the CPU 65 determines that the application execution state is not ended (i.e., the state is maintained) (Step T10; No), then the process returns to Step T9. If it is determined that the state is ended (Step T10; Yes), then the process returns to Step T2.

In Step T7, if it is determined that no operation for executing the application is performed on the application icon M (Step T7; No), then the CPU 65 determines whether an operation for detecting a common data application is performed on the application icon M by a user or not (Step T11). The operation for detecting the common data application is an operation for detecting an application having usable data in common with the application specified by a user, and is, for example, an operation such that a user touches any application icon M for a predetermined time (e.g., two seconds) or more.

In Step T11, if it is determined that no operation for detecting the common data application is performed by a user (Step T11; No), then the CPU 65 determines whether another operation is performed by a user or not (Step T12). If it is determined that another operation is performed (Step T12; Yes), then the CPU 65 executes the process in accordance with the operation. If it is determined that another operation is not performed (Step T12; No), then the process returns to Step T2.

In Step T11, if it is determined that the operation for detecting the common data application is performed on the application icon M by a user (Step T11; Yes), then the CPU 65 detects and identifiably displays the application having usable data in common with the application of the application icon M specified by a user (hereinafter, referred to as “a specified application icon M1” (for example, see FIG. 16B)) (Step T13).

Specifically, the CPU 65 detects the data types usable in both the application of the specified application icon M1 and other applications, from the multiple data types corresponding to the application icons M displayed on the touch screen 61 based on the icon information data 642 read from the memory 64. That is, the CPU 65 detects the application icons (hereinafter, referred to as “corresponding application icons M2” (for example, see FIG. 16B)) of the applications having usable data types in common with the application of the specified application icon M1, among all the application icons M except the specified application icon M1 from the icon information data 642.

The CPU 65 then identifiably displays the specified application icon M1 and the corresponding application icons M2 individually. The identifiable display only needs to distinguish the specified application icon M1, the corresponding application icons M2, and the application icons M other than the icons M1 and M2; and an example of the identifiable display includes surrounding the specified application icon M1 and the corresponding application icons M2 with frames of different colors.

At this time, the CPU 65 further identifiably displays a corresponding application icon M2, for which the data types are completely shared with the application of the specified application icon M1 (are used in common), and a corresponding application icon M2, for which the data types are only partially shared with the application of the specified application icon M1, among the corresponding application icons M2. An example of the identifiable display includes surrounding the corresponding application icon M2, for which the data types are completely shared with the application of the specified application icon M1, with a solid color frame; and surrounding the corresponding application icon M2, for which the data types are only partially shared with the application of the specified application icon M1, with a dashed color frame.

The CPU 65 then determines whether the specified application icon M1 and a corresponding application icon M2 displayed on the touch screen 61 are brought close to each other according to a user operation or not (Step T14). If it is determined that they are not brought close to each other (Step T14; No), then the process goes to Step T12.

In Step T14, if it is determined that the specified application icon M1 and a corresponding application icon M2 are brought close to each other (Step T14; Yes), then the CPU 65 displays the data icons N (for example, see FIG. 17A) corresponding to the data types detected in Step T13 in association with each of the application icons M on the touch screen 61 (Step T15). Specifically, the CPU 65 retrieves the data icons N corresponding to the data types usable in both of the applications from the icon information data 642 and displays them in association with each of the specified application icon M1 and the corresponding application icon M2.

At this time, the CPU 65 identifiably displays the data icons N in the same manner as the corresponding application icon M (the specified application icon M1 or the corresponding application icon M2). Additionally, the CPU 65 distinguishably displays the data icon N representing the data type that requires conversion of the data format for use in another application from the data icon N representing the data type that does not require such a conversion.

The CPU 65 then determines whether a data icon N associated with one of the application icons M (i.e., one of the specified application icon M1 and the corresponding application icon M2) is moved onto the other of the application icons M (i.e., the other of the specified application icon M1 and the corresponding application icon M2) according to a user operation (Step T16).

In Step T16, if it is determined that a data icon N associated with one of the application icons M is moved onto the other of the application icons M (Step T16; Yes), then the CPU 65 moves or copies the data of the data type corresponding to the data icon N to the application represented by the other application icon M and allows the data to be used in the application data (Step T17). The process then returns to Step T2.

At this time, the CPU 65 determines whether to move or copy the data according to the moving operation of the data icon N by a user. If the data is moved, then the data is eliminated from the source application. If the data corresponding to the moved data icon L requires conversion of its data format when used in the destination application, the data format is converted by the CPU 65 to be used in the destination application.

In Step T16, if it is determined that a data icon N associated with one application icon M is not moved onto the other application icon M (Step T16; No), then the CPU 65 determines whether the data icons N, which are of the same type, respectively associated with the two application icons M (the specified application icon M1 and the corresponding application icon M2) are exchanged according to a user operation or not (Step T18).

In Step T18, if it is determined that the data icons N associated with the two application icons M are not exchanged (Step T18; No), then the CPU 65 goes to another process.

In Step T18, if it is determined that the data icons N associated with the two application icons M are exchanged (Step T18; Yes), then the CPU 65 exchanges the data of the data types corresponding to the data icons N between the two applications represented by the two application icons M (Step T19). The process then returns to Step T2.

### [2.3 Example of Operation of Mobile Terminal 6]

An operation of the mobile terminal 6 described above will now be described with specific examples.

FIGS. 16A to 19C illustrate example display screens on the touch screen 61 in the information display control process described above.

When a user performs the information display control process through a predetermined operation, the application icon M of each of application A 643a to application H 643h stored in the memory 64 is displayed on the touch screen 61 (Step T1).

In the following description, the application number (alphabet) of each of the application A 643a to the application H 643h is added to the tail of the symbol of the application icon M to clarify which application icon M corresponds to which application. Specifically, the application icon M of the application A 643a, for example, is referred to an “application icon MA”.

If external data 1 and external data 2 are transmitted from another mobile terminal 66a and an exercise meter 66b (Step T2; No, Step T4; Yes), then these pieces of external data 1 and 2 are stored in the memory 64 as data 641 received from the external devices (Step T5) and the pieces of application information on the pieces of external data 1 and 2 are registered in icon information data 642 (Step T6). Note that the external data 1 is data for the running application and the external data 2 is data on exercise (see FIG. 14).

With reference to FIG. 16A, the two application icons M+ of the pieces of the external data 1 and 2 newly registered in the icon information data 642 appear on the touch screen 61 (Step T1). These two application icons M+ are labeled with a symbol “+” representing external data.

With reference to FIG. 16B, if a user performs an operation for detecting the common data application through touching the application icon MA for the application A 643a for two seconds or more (Step T2; No, Step T4; No, Step T7; No, Step T11; Yes), then the colored application icon MA is displayed as a specified application icon M1, and an application icon MC, an application icon ME, and the application icons M+ for the external data 1 and 2 are detected as the corresponding application icons M2 based on the icon information data 642 and are surrounded by color frames having a color different from that of the specified application icon M1 (Step T13).

With reference to FIG. 16C, if the specified application icon M1 is moved to the right to be swapped with the application icon MB on the right through a drag operation by a user and then is brought close to the corresponding application icon M2 (the application icon MC) by further movement to the right as shown in FIG. 17A (Step T14; Yes), then multiple data icons N corresponding to multiple data types usable in both of the applications are read from the icon information data 642, and are displayed such that the data icons N are partly overlapped with the adjacent sides of the two application icons M (Step T15). At this time, the multiple data icons N displayed on each of the application icons M (the application icon MA and the application icon MC) correspond to movement distance data, GPS movement track data, and exercise data (see FIG. 14). In addition, the data icons N are identifiably displayed in the same manner as the corresponding application icon M. That is, each of the data icons N associated with the specified application icon M1 (the application icon MA) is displayed with color and each of the data icons N associated with the corresponding application icon M2 (the application icon MC) is surrounded by a solid color frame.

To perform a touch operation without any erroneous operation (any false touch) for the data icons N smaller than the application icon M, the area around a portion in which the data icons N are displayed (e.g., the area indicated by the two-dot chain line in FIG. 17A) may be enlarged.

With reference to FIG. 17B, if a user taps the data icon N of the movement distance data associated with the corresponding application icon M2, then a new data icon N of the movement distance data appears adjacent to the data icon N for copying.

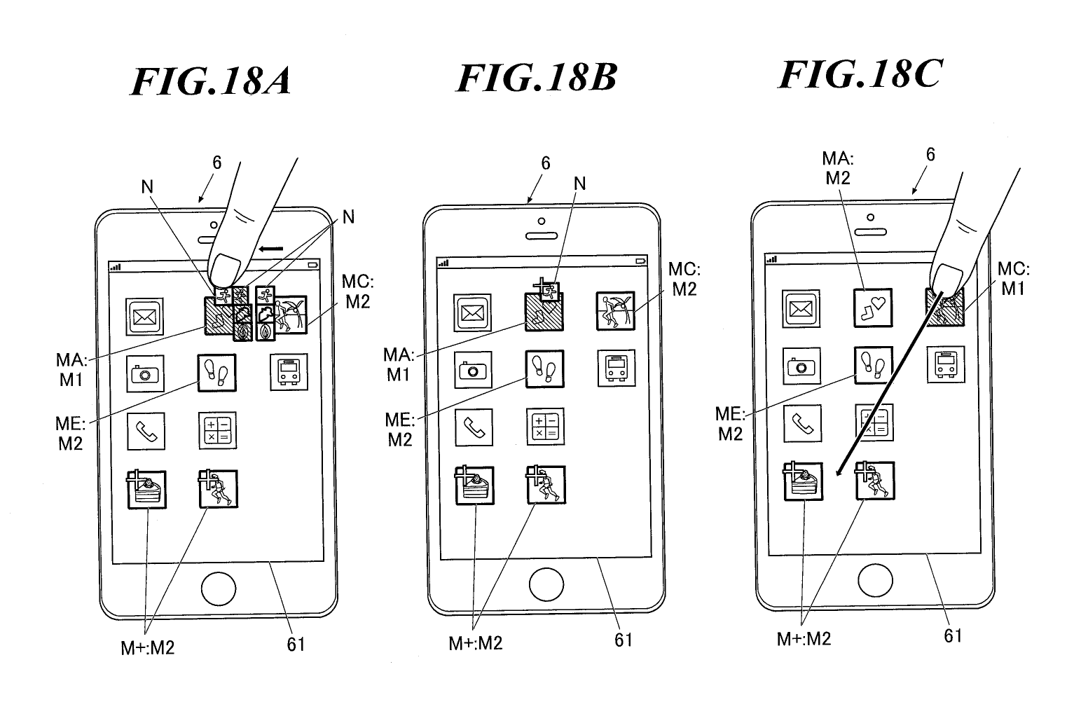

With reference to FIGS. 17B and 18A, if a user moves the data icon N of the movement distance data for copying onto the specified application icon M1 while switching the place with the data icon N associated with the specified application icon M1 (Step T16; Yes), then the movement distance data associated with the corresponding application icon M2 is copied to the application (the running application with a heartbeat sensor) represented by the specified application icon M1 (Step T17).

With reference to FIG. 18B, if the device is left for a little while without any touch operation, then the data icons N that are not changed before and after the copy operation are eliminated and the data icon N of the copied movement distance data provided with a symbol “+” indicating additional data is displayed. If the device is further left in this state, then the identifiable display of the respective application icons M is eliminated together with the data icon N of the movement distance data (not shown).

If a user performs an operation for detecting the common data application through touching the application icon MC of the application C 643c for two seconds or more (Step T2; No, Step T4; No, Step T7; No, Step T11; Yes), then the colored application icon MC is displayed as the specified application icon M1, and an application icon MA, an application icon ME, and the application icons M+ for the external data 1 and 2 are detected as the corresponding application icons M2 based on the icon information data 642 and are surrounded by color frames having a color different from that of the specified application icon M1 (Step T13).

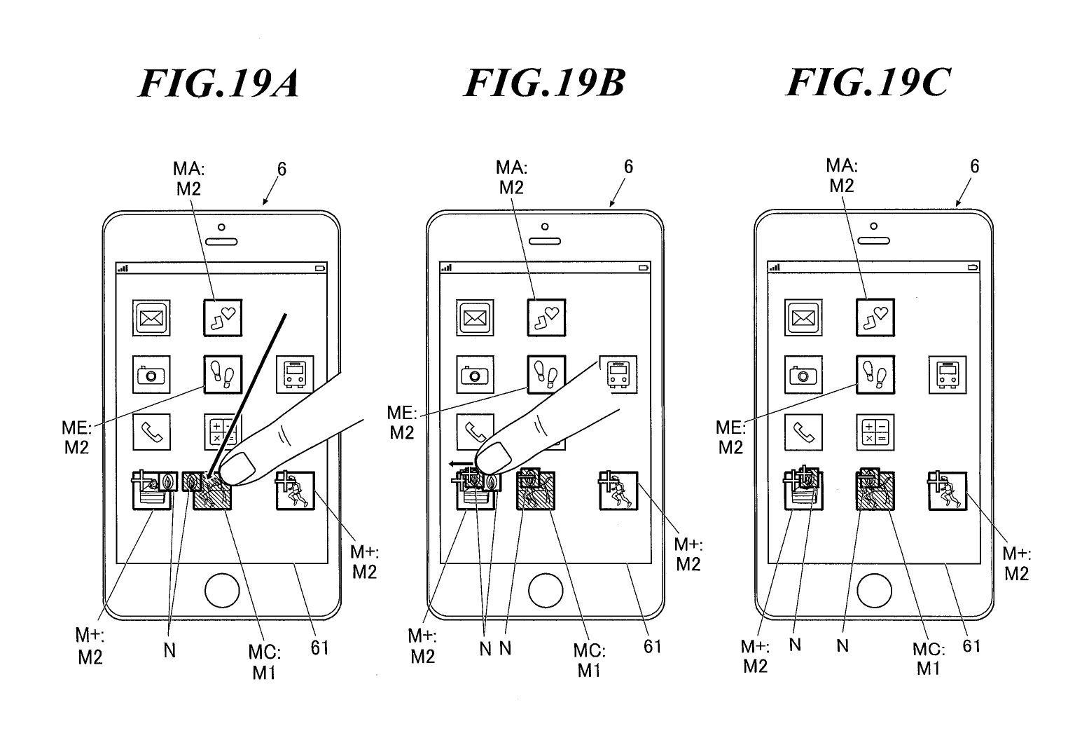

With reference to FIG. 18C, if a user moves the specified application icon M1 obliquely downward to the left through a drag operation and moves the specified application icon M1 to the position between the two application icons M+, then the application icon M+ of the external data 1 is pushed to the right side. If a user further moves the specified application icon M1 through a drag operation to bring the specified application icon M1 close to the corresponding application icon M2 (the application icon M+ of the external data 2 (Step T14; Yes), then, with reference to FIG. 19A, the data icon N of the exercise data usable in both of the applications is read from the icon information data 642 and appear on the adjacent sides of the two application icons M (Step T15).

If a user moves the data icon N of the exercise data associated with the specified application icon M1 from the specified application icon M1 through a drag operation without tapping, then the data icon N is duplicated. One of the data icons N is displayed with a symbol “−” indicating the data to be deleted while being associated with the specified application icon M1 (remaining in the original position), and the other data icon N is displayed with a symbol “+” indicating data to be added to another application and is moved in accordance with user's drag operation.

With reference to FIG. 19B, if a user moves the data icon N of the exercise data onto the corresponding application icon M2 (the application icon M+ of the external data 2) (Step T16; Yes), then the exercise data corresponding to the specified application icon M1 is moved into the exercise data corresponding to the corresponding application icon M2 (Step T17).

With reference to FIG. 19C, if the device is left for a little while without any touch operation, then the data icon N that is not changed before and after the moving operation is eliminated. If the device is further left in this state, then the identifiable display of the respective application icons M is eliminated together with the data icon N of the exercise data (not shown).

The second embodiment can achieve the same advantageous effects as the first embodiment.

The first and second embodiments of the present invention described above can be appropriately modified without departing from the scope of the present invention.

For example, the information display control devices according to the invention are the personal computer 4 and the mobile terminal 6. The invention however should not be limited to these products and can be applied to a variety of electronic devices, such as mobile phones, personal digital assistants (PDAs), and game devices.

If the two application icons K (M) are brought close to each other, then a data icon L (N) is displayed in association with each of the application icons K (M), but the mark displayed at this time may not be the data icon L (N) but may be any other mark that represents a data type and can be distinguished from the one representing another data type.

The scope of the invention should not be limited to the above-mentioned embodiments and includes the scope of the invention described in the appended claims and the range of equivalents.

The entire disclosure of Japanese Patent Application No. 2013-195314 filed on Sep. 20, 2013 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. An information display control device comprising:
a display unit;
an icon display controller that displays a plurality of application icons on the display unit; and
a usable data display controller that displays a mark on the display unit in association with each of the application icons, the mark representing a data type usable in common in applications among a plurality of data types corresponding to the application icons displayed by the icon display controller.

2. The information display control device according to claim 1, wherein
the usable data display controller displays the mark representing the data type as a data icon; and
when the data icon associated with a first application icon is moved onto a second application icon according to a user operation, data of the data type corresponding the data icon associated with the first application icon displayed by the usable data display controller is usable in an application represented by the second application icon.

3. The information display control device according to claim 1, further comprising an icon identifiably-displaying controller that identifiably displays a first application icon specified according to a user operation and a second application icon among the application icons displayed by the icon display controller, wherein an application represented by the first application icon and an application represented by the second application icon have the usable data type in common.

4. The information display control device according to claim 3, wherein, when the first application icon and the second application icon displayed on the display unit are brought close to each other according to the user operation, the usable data display controller displays the mark in association with each of the first application icon and the second application icon.

5. The information display control device according to claim 1, wherein
the usable data display controller distinguishably displays the mark representing the data type that requires conversion of a data format to be used in another application from the mark representing the data type that does not require the conversion; and
when the mark representing the data type that requires the conversion is moved onto an application icon representing the another application according to a user operation, the data format of the moved mark is converted to be usable in the another application.

6. The information display control device according to claim 1, further comprising a communication unit through which data communication is performed with another device, wherein
when external data is transmitted from the another device through the communication unit, the icon display controller displays an application icon representing the external data on the display unit.

7. The information display control device according to claim 1, further comprising:
an icon information storage unit that stores a plurality of application icons representing applications in association with information including data types of a plurality of pieces of data used in the applications; and
a data type detector that detects a data type usable in common in the applications among the data types corresponding to the application icons displayed by the icon display controller, based on the information stored in the icon information storage unit, wherein
the usable data display controller displays the mark on the display unit in association with each of the application icons, the mark representing the data type detected by the data type detector.

8. The information display control device according to claim 7, wherein
the icon information storage unit stores the data types of the pieces of data in such a way that each of the data types is associated with a data icon representing the corresponding data type; and
the usable data display controller reads the data icon corresponding to the data type detected by the data type detector from the icon information storage unit and displays the read data icon on the display unit as the mark.

9. An information display control method for a computer including a display unit, the method comprising:
displaying a plurality of application icons on the display unit; and
displaying a mark on the display unit in association with each of the application icons, the mark representing a data type usable in common in applications among a plurality of data types corresponding to the displayed application icons.

10. A non-transitory storage medium containing an information display control program to be executed by a computer including a display unit, the program making the computer realize functions of:
an icon display controller that displays a plurality of application icons on the display unit; and
a usable data display controller that displays a mark on the display unit in association with each of the application icons, the mark representing a data type usable in common in applications among a plurality of data types corresponding to the application icons displayed by the icon display controller.
